(19) United States
(12) Patent Application Publication
(10) Pub. No.: US 2014/0187297 A1
(43) Pub. Date: Jul. 3, 2014

(54) TOUCH-CONTROL ACCESSORY HAVING A CLEANING FUNCTION, CELL PHONE SHIELD WITH SAID TOUCH-CONTROL ACCESSORY

(71) Applicant: SONMII ENTERPRISE CO., LTD, Taipei (TW)

(72) Inventors: Chia-Wei Chang, Taipei City (TW); Li-Xuan Sun, Taipei City (TW)

(73) Assignee: SONMII ENTERPRISE CO., LTD, Taipei (TW)

(21) Appl. No.: 13/733,678

(22) Filed: Jan. 3, 2013

(51) Int. Cl. H04M 1/02

(52) U.S. Cl. CPC H04M 1/0202
USPC 455/575.8; 345/179

(57) ABSTRACT

A touch-control accessory having a cleaning function and a cell phone shield carrying the touch-control accessory are disclosed. The cell phone shield includes a shield body having an accommodation chamber surrounded by a back wall and a coupling hole cut through the back wall, and a touch-control accessory detachably mounted in the coupling hole of the shield body and defining an electrically conductive touch-control area for touching the touchscreen of the cell phone to perform touch control functions and a wiping area for cleaning the touchscreen of the cell phone.

### BACKGROUND OF THE INVENTION

1. Field of the Invention

The present invention relates to cell phone protective coverings and more particularly, to a cell phone shield, which is equipped with a touch-control accessory that can be used as a touch screen stylus as well as a touchscreen wiper.

2. Description of the Related Art

In recent years, smart phone has become one of the most favored consumer electronic products. Smart phones having different functions and different sizes are launched one after another by major 3C products companies to meet the needs of all levels of consumers.

The major difference between smart phones and regular phones is that smart phones have big screen sizes and typically high resolution screens for consumers intuitive touch operation of various functions. Except click-and-drag finger touch operation, smart phones allow the use of a stylus to input commands to the touchscreen.

A smart phone user may carry the touch screen stylus in an accommodation groove at the smart phone, or put it in the pocket like the way of carrying a writing pen. Conventional touch screen styli are simply designed for touchscreen touch control. They cannot be used to wipe fingerprints or dust out of the touchscreen. Further, a smart phone user may use a cell phone shield to protect the smart phone and to show personal styles. However, conventional cell phone shields simply provide a physical appearance protection function without other added functions. Multifunction integration is the development priority of smart phone accessories.

### SUMMARY OF THE INVENTION

The present invention has been accomplished under the circumstances in view. It is the main object of the present invention to provide a touch-control accessory, which can be used as a touch screen stylus as well as a touchscreen wiper. It is another object of the present invention to provide a cell phone shield, which is equipped with a detachable touch-control accessory that can be used as a touch screen stylus as well as a touchscreen wiper.

To achieve these objects of the present invention, a cell phone shield comprises a shield body and a touch-control accessory. The shield body comprises a back wall, a peripheral wall perpendicularly extending around the border of the back wall, an accommodation open chamber surrounded by the back wall and the peripheral wall for accommodating a cell phone, and a coupling hole cut through the back wall and disposed in communication with the accommodation open chamber. The touch-control accessory is detachably mounted in the coupling hole of the shield body, comprising opposing inner side and outer side, and a wiping area and a touch-control area disposed at the inner side. The outer side of the touch-control accessory is disposed outside the back wall after the touch-control accessory is mounted in the coupling hole of the shield body.

The touch-control accessory further comprises an engagement structure disposed between the touch-control area and the wiping area. The engagement structure comprises a neck, and two opposing wing portions extended from the periphery of the neck. Further, the coupling hole defines therein an internal stop flange for stopping the engagement structure in the coupling hole.

Further, the coupling hole of the shield body defines a first inner diameter at one side of the internal stop flange and a second inner diameter at an opposite side of the internal stop flange. Further, the orthographic projection plane of the first inner diameter is partially overlapped with the orthographic projection plane of the second inner diameter. Thus, by means of aiming the engagement structure of the touch-control accessory at the first inner diameter of the coupling hole, the engagement structure can be inserted into the coupling hole and then stopped therein after through a rotary motion. When reversing the procedure, the touch-control accessory can be removed from the shield body for application.

### BRIEF DESCRIPTION OF THE DRAWINGS

FIG. 1 is an elevational view of a cell phone shield with a touch-control accessory having a cleaning function in accordance with the present invention.

FIG. 2 is an exploded view of the cell phone shield in accordance with the present invention.

FIG. 3 is a schematic sectional view of the present invention, illustrating the engagement structure of the touch-control accessory fastened to the coupling hole of the shield body.

FIG. 4 is a schematic drawing illustrating a touch control application of the touch-control accessory in accordance with the present invention.

FIG. 5 is a schematic drawing illustrating a touchscreen wiping application of the touch-control accessory in accordance with the present invention.

FIG. 6 illustrates the touch-control accessory configured subject to an animal pattern in accordance with the present invention.

### DETAILED DESCRIPTION OF THE INVENTION

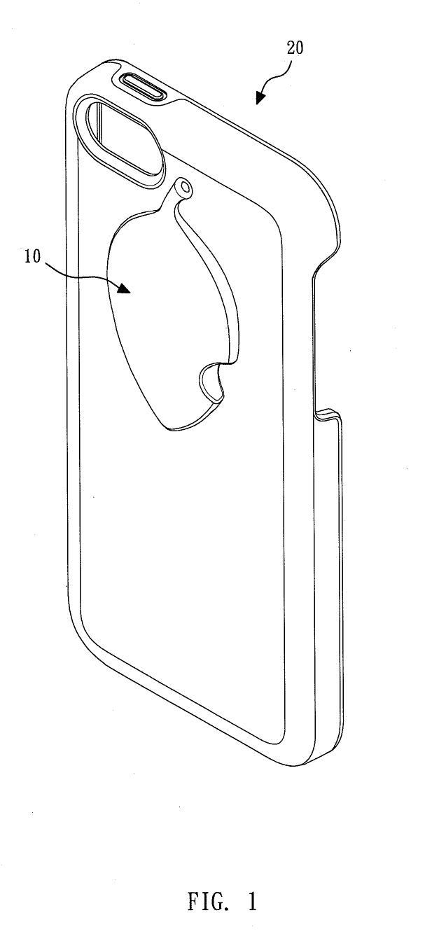

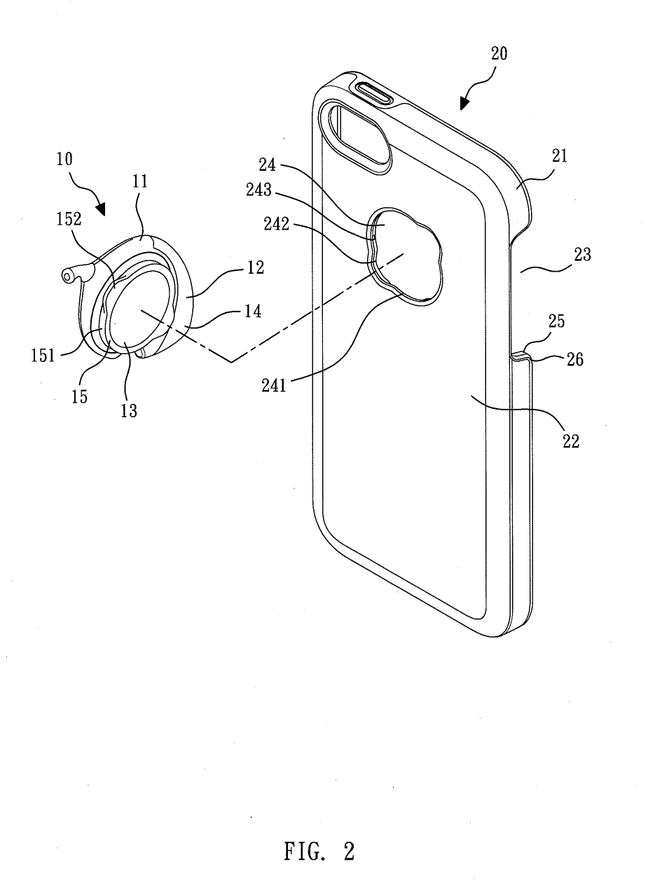

Referring to FIGS. 1 and 2, a cell phone shield with a touch-control accessory having a cleaning function in accordance with the present invention is shown. The cell phone shield comprises a touch-control accessory 10 and a shield body 20. The shield body 20 is adapted to hold and protect a cell phone. The touch-control accessory 10 is detachably mounted in the shield body 20 to facilitate portability with the cell phone.

The touch-control accessory 10 comprises a flat base 11, and a touch-control area 12 and a wiping area 13 disposed at one side of the flat base 11. The wiping area 13 provides multiple microfibers. The touch-control area 12 is electrically conductive, and disposed at one lateral side of the wiping area 13. The wiping area 13 is disposed at a relatively higher elevation than the touch-control area 12, facilitating wiping. The flat base 11 can be configured subject to a predetermined plant pattern, for example, in the shape of a leaf of a plant. The patterned flat base 11 defines at least one pointed portion 14, facilitating touch control operation of the touch-control area 12. The touch-control accessory 10 further comprises an engagement structure 15 surrounding the wiping area 13. The engagement structure 15 comprises a neck 151 and two opposing wing portions 152 transversely extended from the periphery of the neck 151.

The shield body 20 comprises a back wall 22, a peripheral wall 21 perpendicularly extending around the border of the back wall 22, and an accommodation open chamber 23 surrounded by the back wall 22 and the peripheral wall 21 for accommodating a cell phone, and a coupling hole 24 cut through the back wall 22 and disposed in communication with the accommodation open chamber 23. The coupling hole 24 defines a first inner diameter 241, a second inner diameter 242, and an internal stop flange 243 disposed between the first inner diameter 241 and the second inner diameter 242. The first inner diameter 241 is defined in one side, namely, the outer side of the back wall 22 remote from the accommodation open chamber 23. The second inner diameter 242 is defined in an opposite side, namely, the inner side of the back wall 22 in proximity to the accommodation open chamber 23. The configuration of the first inner diameter 241 fits the configuration of the engagement structure 15 so that the engagement structure 15 can be inserted through the first inner diameter 241 and engaged into the second inner diameter 242. The orthographic projection plane passing through the first inner diameter 241 is partially overlapped with the orthographic projection plane of the second inner diameter 242. Thus, the engagement structure 15 of the touch-control accessory 10 can be aimed at the first inner diameter 241 and inserted into the coupling hole 24. After insertion of the engagement structure 15 of the touch-control accessory 10 into the coupling hole 24, rotate the touch-control accessory 10 through a predetermined angle to engage the engagement structure 15 into the second inner diameter 242, enabling the touch-control accessory 10 to be joined to the shield body 20. Further, the shield body 20 is a double layer member formed of an inner layer 25 and an outer layer 26 that are integrally molded together. The inner layer 25 can be made from thermoplastic polyurethane (TPU). The outer layer 26 can be made from polycarbonate (PC). Thus, the inner layer 25 has a hardness smaller than that of the outer layer 26, and does not scratch the accommodated cell phone. It's worth mentioning that the second inner diameter 242 is formed in the inner layer 25, and the first inner diameter 241 is formed in the outer layer 26.

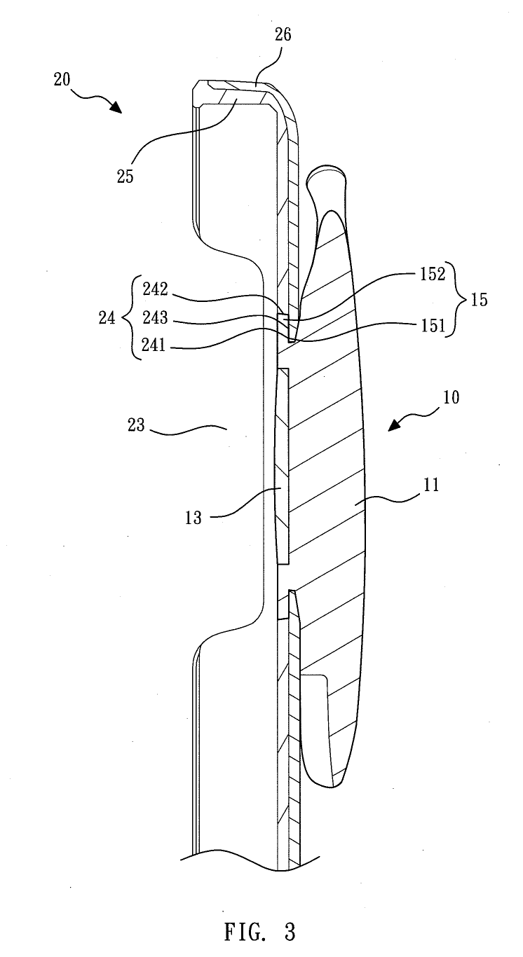

Referring to FIG. 3, the touch-control accessory 10 is shown installed in the coupling hole 24 of the shield body 20. By means of aiming the engagement structure 15 of the touch-control accessory 10 at the first inner diameter 241, the engagement structure 15 can be inserted into the coupling hole 24. When rotating the touch-control accessory 10 through a predetermined angle after insertion of the engagement structure 15 into the coupling hole 24, the neck 151 of the engagement structure 15 is received in the first inner diameter 241, and the wing portions 152 of the engagement structure 15 are received in the second inner diameter 242. Subject to the design that the orthographic projection plane passing through the first inner diameter 241 is partially overlapped with the orthographic projection plane of the second inner diameter 242, the wing portions 152 are stopped at the internal stop flange 243 between the first inner diameter 241 and the second inner diameter 242 to prohibit the touch-control accessory 10 from axial displacement in the coupling hole 24. Thus, the touch-control accessory 10 and the shield body 20 are positively secured together for holding a cell phone and providing an added function.

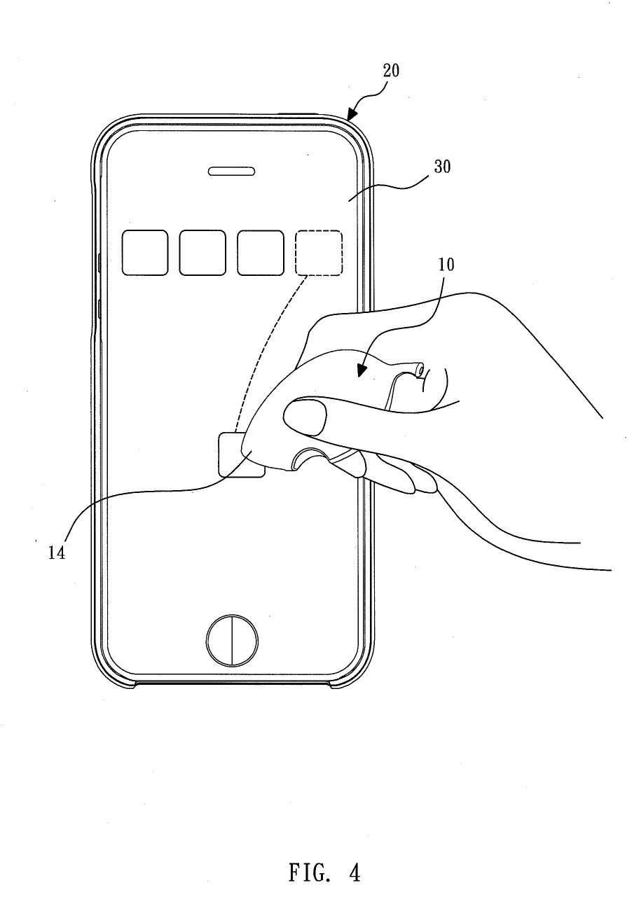

FIG. 4 illustrates an application example of the cell phone shield. When a cell phone 30 is accommodated in the shield body 20, the user can detach the touch-control accessory 10 from the shield body 20 and touch and drag the pointed portion 14 of the touch-control accessory 10 over the touchscreen of the cell phone 30 to touch-control the functions of the cell phone 30.

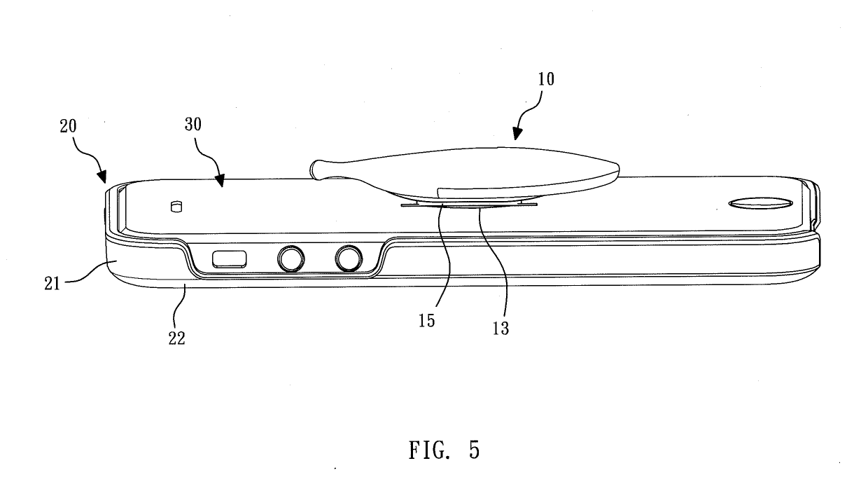

FIG. 5 illustrates another application example of the cell phone shield. The user can use the wiping area 13 of the touch-control accessory 10 to wipe out fingerprints or dust from the touchscreen of the cell phone 30. Thus, in addition to touch control function, the touch-control accessory 10 provides an added cleaning function, enhancing the applicability of the cell phone shield.

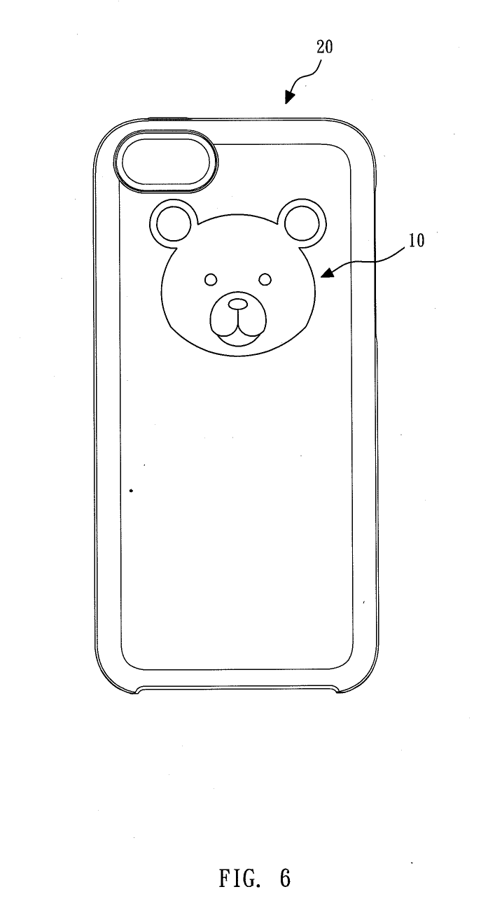

Referring to FIG. 6, the touch-control accessory 10 can also be configured to show the shape of the face of an animal, for example, the shape of the face of a panda, attracting consumers to buy the cell phone shield.

In conclusion, the invention provides a cell phone shield, which comprises a shield body for holding a cell phone, a touch-control accessory detachably mounted in the shield body for use as a touch screen stylus as well as a touchscreen wiper for cleaning the touchscreen of the accommodated cell phone.

Further, because the touch-control accessory is detachably attached to the back wall of the shield body but not mounted at the cell phone, it facilitates carrying and can be configured subject to a predetermined animal or plant pattern to decorate the cell phone shield, enhancing the sense of beauty of the cell phone shield and attracting consumers to buy the cell phone shield.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A touch-control accessory, comprising:
a flat base;
a wiping area disposed at one side of said flat base, said touch-control area comprising a plurality of microfibers; and
a touch-control area disposed at said flat base at one lateral side of said wiping area, said touch-control area being electrically conductive.

2. The touch-control accessory as claimed in claim 1, wherein said touch-control area and said wiping area are disposed at different elevations.

3. The touch-control accessory as claimed in claim 1, wherein said flat base comprises at least one pointed portion.

4. A cell phone shield, comprising:
a shield body comprising a back wall, a peripheral wall perpendicularly extending around the border of said back wall, an accommodation open chamber surrounded by said back wall and said peripheral wall for accommodating a cell phone, and a coupling hole cut through said back wall and disposed in communication with said accommodation open chamber; and
a touch-control accessory detachably mounted in said coupling hole of said shield body, said touch-control accessory comprising opposing inner side and outer side, and a wiping area and a touch-control area disposed at said inner side, the outer side of said touch-control accessory being disposed outside said back wall after installation of said touch-control accessory in said coupling hole of said shield body.

5. The cell phone shield as claimed in claim 4, wherein said touch-control area and said wiping area are disposed at different elevations.

6. The cell phone shield as claimed in claim 4, wherein said touch-control accessory further comprises an engagement structure disposed between said touch-control area and said wiping area.

7. The cell phone shield as claimed in claim 6, wherein said engagement structure surrounds said wiping area.

8. The cell phone shield as claimed in claim 6, wherein said engagement structure comprises a neck, and two opposing wing portions extended from the periphery of said neck; said coupling hole defines therein an internal stop flange for stopping said engagement structure in said coupling hole.

9. The cell phone shield as claimed in claim 8, wherein said coupling hole further defines a first inner diameter at one side of said internal stop flange and a second inner diameter at an opposite side of said internal stop flange, the orthographic projection plane of said first inner diameter being partially overlapped with the orthographic projection plane of said second inner diameter.

10. The cell phone shield as claimed in claim 9, wherein said first inner diameter is configured to fit the shape of said engagement structure.

11. The cell phone shield as claimed in claim 4, wherein said touch-control accessory comprises at least one pointed portion.

12. The cell phone shield as claimed in claim 4, wherein said shield body comprises an inner layer and an outer layer, the hardness of said inner layer being smaller than the hardness of said outer layer.
